(19) United States
(12) Patent Application Publication
(10) Pub. No.: US 2009/0227325 A1
(43) Pub. Date: Sep. 10, 2009

(54) SLOT MACHINE HAVING VARIETY OF AWARDS WITH POINT-ALLOCATED SYMBOLS AND CONTROL METHOD THEREOF

(75) Inventor: Fumiya Abe, Koto-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Gaming America, Inc., Las Vegas, NV (US)

(21) Appl. No.: 12/136,346

(22) Filed: Jun. 10, 2008

Related U.S. Application Data
(60) Provisional application No. 61/034,732, filed on Mar. 7, 2008.

(51) Int. Cl. A63F 13/00

(52) U.S. Cl. 463/20

(57) ABSTRACT

In a slot machine, symbols are scrolled in plural display areas provided on a display at an execution of a slot game and then stopped in the display areas respectively. Furthermore, points are displayed nearby each of the symbols. If total points allocated to all identical symbols are equal-to or more-than a predetermined value, an award according to the total points. Therefore, a degree of the award can be determined according to the symbols displayed in the display areas and the points allocated to each of the symbols.

### CROSS-REFERENCE TO RELATED APPLICATION

This application is based upon and claims the benefit of U.S. Provisional Patent Application Ser. No. 61/034,732, filed on Mar. 7, 2008; the entire contents of which are incorporated herein by reference for all purposes.

### BACKGROUND OF THE INVENTION

1. Field of the Invention

The present invention relates to a slot machine for playing games using medals and so on, and a control method of a slot machine.

2. Description of Related Art

Each slot machine disclosed in U.S. Pat. No. 6,960,133 B1 and U.S. Pat. No. 6,012,983 is known as a relevant slot machine. In the slot machine, for example, total fifteen symbols in a three-rows by five-columns arrangement start scrolling in display areas on a display provided on a front face of a cabinet after a player has inserted monetary value(s), such as a medal(s), a coin(s) or a bill(s), into an insertion slot of the slot machine and has pressed a start switch, and then the symbols automatically come to stops. After the fifteen symbols has come to stops, appearing a prescribed number of scatter symbols causes an award.

In the slot machine, an award is determined only according to the number of appearing scatter symbols and then a slot machine having a new entertainment feature is desired to be produced.

### SUMMARY OF THE INVENTION

A first aspect of the present invention provides a slot machine that includes a display including plural display areas in which symbols are arranged and points are allocated to the symbols, and a controller. The controller is operable to rearrange symbols in the display areas after receiving an input from an external and also change points of the symbols in the display areas, and provide, when total points allocated to all identical symbols are equal-to or more-than a predetermined value, an award according to the total points.

A second aspect of the present invention provides a slot machine that includes a display including plural display areas in which symbols are arranged and points are allocated to the symbols, and a controller operable to (A) rearrange symbols in the display areas after receiving an input from an external, (B) allocate points to each of the rearranged symbols, and (C) provide, when total points allocated to all identical symbols are equal-to or more-than a predetermined value, an award according to the total points.

A third aspect of the present invention provides a slot machine that includes a display including plural display areas in which symbols are arranged and points are allocated to the symbols, an awards setting table in which relationships between a total of the points and an award are defined and the awards are defined higher as the total of the points becomes larger, and a controller. The controller is operable to rearrange symbols in the display areas after receiving an input from an external and also change points of the symbols in the display areas, and provide, when total points allocated to all identical symbols are equal-to or more-than a predetermined value, an award according to the total points with reference to the awards setting table.

A fourth aspect of the present invention provides a control method of a slot machine that includes, rearranging symbols had been arranged in plural display areas provided on a display and allocating points to each of the symbols, and providing, when total points allocated to all identical symbols are equal-to or more-than a predetermined value, an award according to the total points.

### BRIEF DESCRIPTION OF THE DRAWINGS

FIG. 1 is a screen example showing symbols and points displayed on a display of a slot machine of embodiments according to the present invention;

FIG. 2 is an example of an awards setting table used in the embodiments of the slot machine according to the present invention;

FIG. 3 is an overall view showing a configuration of the slot machine in a first embodiment according to the present invention;

FIG. 4 is a block diagram showing an internal configuration of the slot machine in the first embodiment according to the present invention;

FIG. 5 is a diagram showing display areas provided on a display of the slot machine in the first embodiment according to the present invention;

FIG. 6 is a flow-chart of slot game execution processing in the first embodiment of the slot machine according to the present invention;

FIG. 7 is a flow-chart of image effect control processing in the first embodiment of the slot machine according to the present invention;

FIG. 8 is a flow-chart of payout processing in the first embodiment of the slot machine according to the present invention;

FIG. 9 is a screen example showing symbols displayed on the display of the slot machine in the first embodiment according to the present invention;

FIG. 10 is a screen example showing symbols and points displayed on the display of the slot machine in the first embodiment according to the present invention;

FIG. 11 is a flow-chart of payout processing in a modified example of the first embodiment according to the present invention;

FIG. 12 is an overall view showing a configuration of the slot machine in a second embodiment of the slot machine according to the present invention;

FIG. 13 is a block diagram showing an internal configuration of the slot machine in the second embodiment of the slot machine according to the present invention;

FIG. 14A is a perspective view of a spinning reel device of the slot machine employed in the second embodiment according to the present invention;

FIG. 14B is a side view of the spinning reel device of the slot machine employed in the second embodiment according to the present invention;

FIG. 15 is an arrangement diagram of symbol rows drawn on each reel of the slot machine in the second embodiment according to the present invention;

FIG. 16 is a flow-chart of slot game execution processing in the second embodiment of the slot machine according to the present invention;

FIG. 17 is a flow-chart of reel control processing in the second embodiment of the slot machine according to the present invention; and

FIG. 18 is a flow-chart of image effect control processing in the second embodiment of the slot machine according to the present invention.

### DETAILED DESCRIPTION OF THE EMBODIMENTS

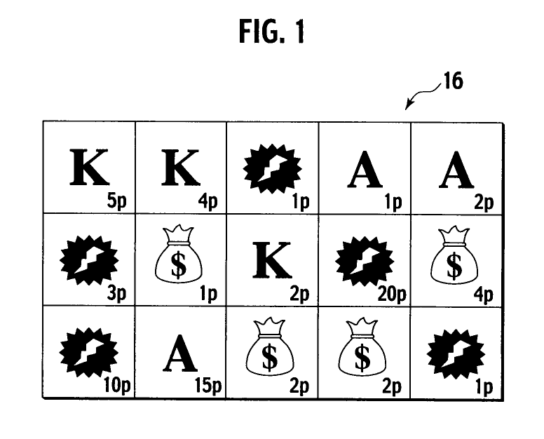

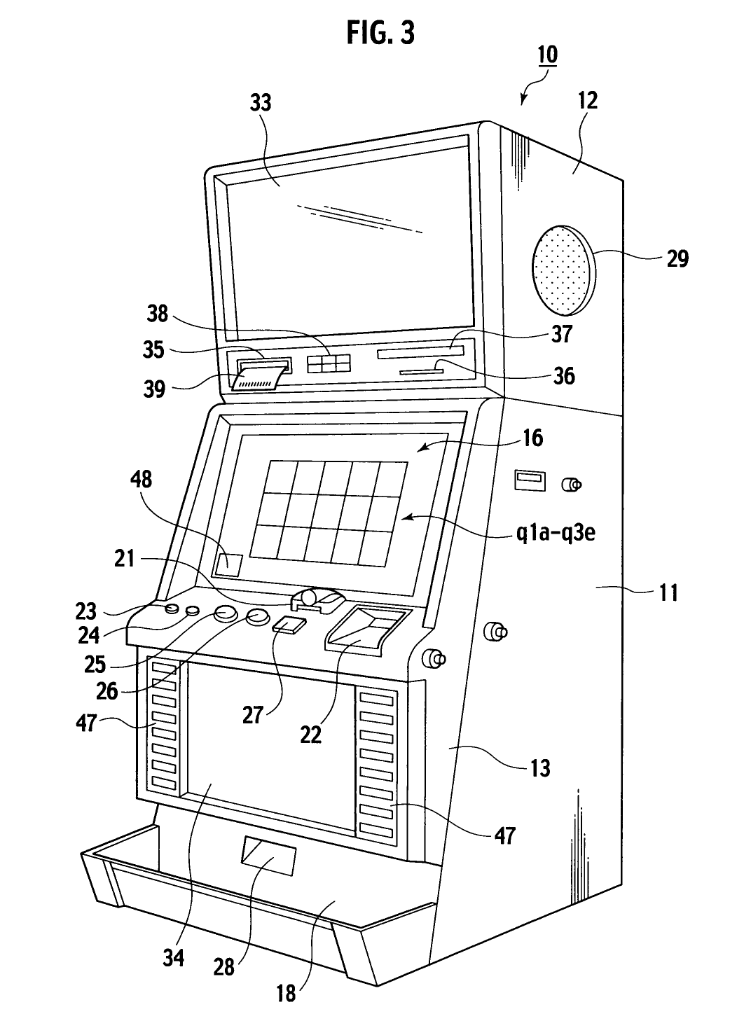

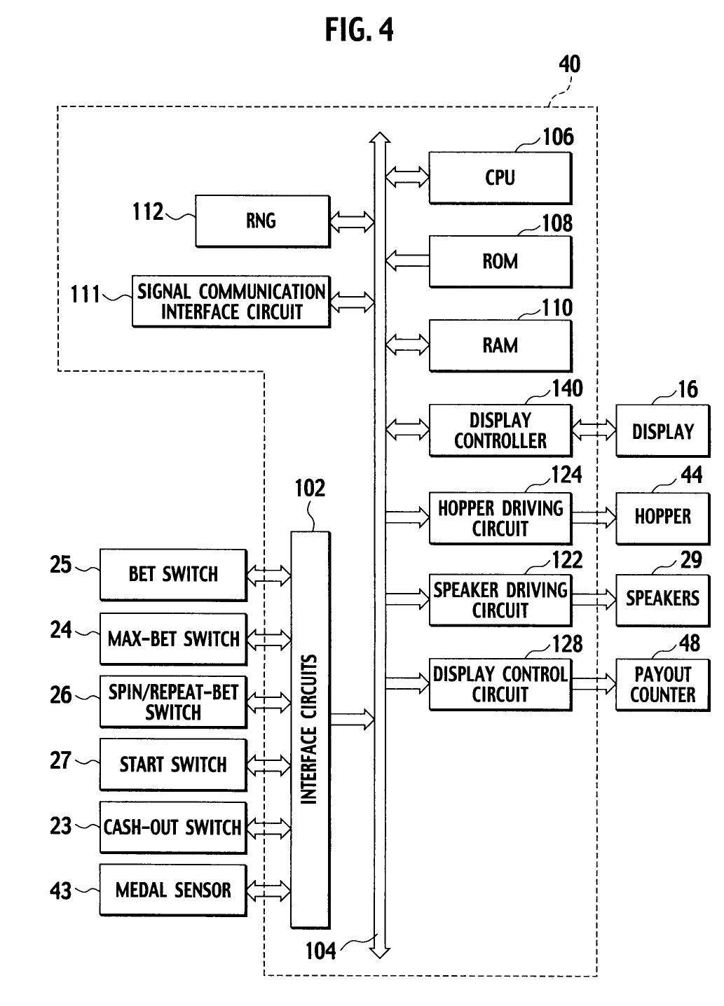

FIG. 1 is an explanatory diagram showing an example of symbols displayed on a display of a slot machine according to the present invention. FIG. 3 is an overall view of the slot machine. FIG. 4 is a block diagram showing an electric configuration of the slot machine according to the present invention.

Total fifteen three-rows by five columns symbols had been displayed in the display areas q1a to q3e shown in FIG. 3 start scrolling after starting a slot game and then come to stops after a predetermined time has elapsed (symbols had been arranged are rearranged). As a result, fifteen symbols are displayed as shown in FIG. 1. Furthermore, points are allocated to each symbol, such as “10p”, “5p” and so on.

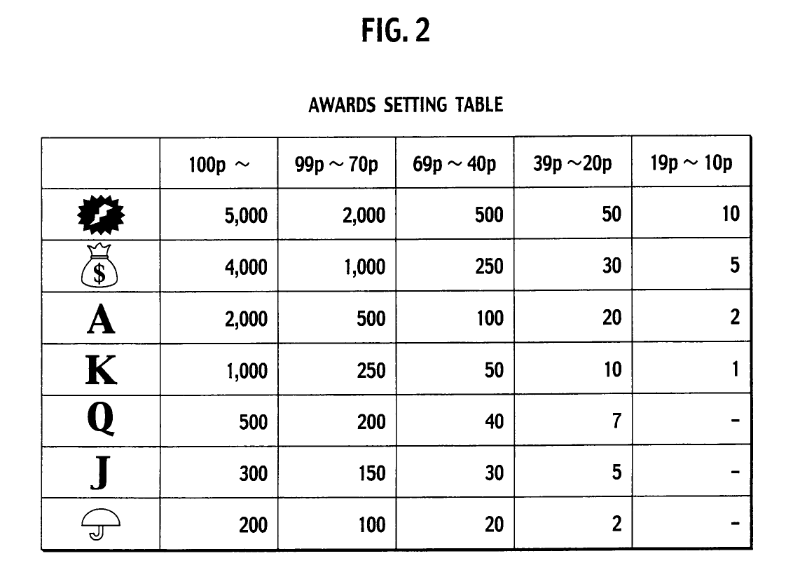

In the slot machine according to the present invention, points allocated to identical symbols are accumulated to calculate a total point and an award is provided when the total points becomes equal-to or more-than a predetermined value. Specifically, an awards setting table shown in FIG. 2 is stored in a RAM 110 shown in FIG. 4 and an award to be provided to a player is determined with reference to the awards setting table. For example, as shown in FIG. 1, in case where five “LIGHTING” symbols have appeared and points 3p, 10p 1p, 20p and 1p have been allocated to each of the “LIGHTING” symbols, a total points are 20 points. Since it corresponds to “39p to 20p” in the awards setting table shown in FIG. 2, a fifty-medal award is provided.

In the slot machine like this, various kinds of awards can be prepared with limited kinds of symbols and then an entertainment feature is advanced.

Next, a configuration of a slot machine 10 in the present embodiment will be explained in detail. As shown in FIG. 3, the slot machine 10 in the present embodiment includes a cabinet 11, a top box 12 provided on top of the cabinet 11 and a main door 13. The cabinet 11 has a display 16 disposed on its plane facing a player. In addition, various component devices are disposed within the cabinet 11, such as the controller 40 (see FIG. 4) for electrically controlling the slot machine 10 and a hopper 44 (see FIG. 4) for controlling an insertion, pooling, and a cash-out of medals.

Here in the present embodiment, medals are used for gaming media used at game executions. However, gaming media are not limited to medals only. For example, coins, tokens, electronic money or other equivalent electronic value information (credits) may be also used as gaming media.

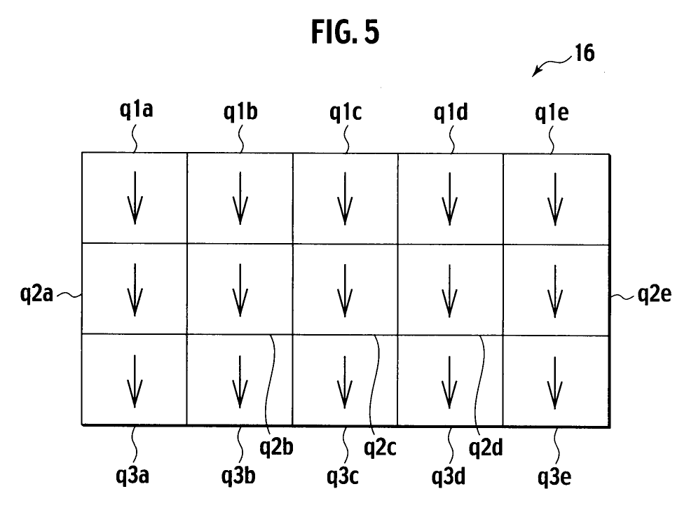

The main door 13 is attached to the cabinet 11 so that it can be opened and closed. The display 16 is disposed on an upper portion of the main door 13. As explained later, images relating to various games including a slot game are displayed on the display 16. As shown in FIG. 5 in a slot game, scrolled and then stopped are symbols which had been displayed in total fifteen display areas q1a to q3e disposed in a three-rows by five-columns matrix manner (symbols had been arranged are rearranged). As explained later, points are allocated to each of the symbols stopped in the display areas q1a to q3e (see FIG. 1 and FIG. 10) and then an award is provided when a total points (e.g. ten points) of all points allocated to identical symbols become equal-to or more-than a predetermined value.

Here, as shown in FIG. 5, suffixes “a” to “e” attached to the display areas “q” are represent columns and suffixes “1” to “3” are represent rows. Note that, in the present embodiment, a slot game is executed with the three-rows by five-columns display areas. However, the present invention is not limited to this.

In addition, a payout counter 48 for displaying a payout amount is disposed at the lower-left area on the display 16 shown in FIG. 3.

A medal insertion slot 21, into which medals are inserted at game plays, and a bill validator 22, which validates bills and accepts valid ones, are disposed beneath the display 16. Various operational switches are disposed nearby the medal insertion slot 21 and the bill validator 22.

A cash-out switch 23, a max-bet switch 24, a bet switch 25, a spin/repeat-bet switch 26 and the start switch 27 are provided as the operational switches.

The bet switch 25 is a switch for determining a bet amount on each slot game executed by on the display 16. Each time the bet switch 25 is pressed, one credit corresponding to one medal is bet.

The spin/repeat-bet switch 26 is a switch for placing a bet again on a current slot game without changing a bet amount had been placed by the bet switch 25 on the last slot game.

The start switch 27 is a switch for starting a slot game after a bet with desired credits has been placed by the bet switch 25. A slot game is started with the display areas q1a to q3e on the display 16 after a bet has been placed by a medal(s) insertion into the medal insertion slot 21 or by the bet switch 25 and then the start switch 27 has been pressed.

The cash-out switch 23 is a switch for cashing out medals being inserted. The medals to be cashed out are discharged from a medal cash-out chute 28 opened in the front lower part of the main door 13 and then pooled on a medal tray 18.

The max-bet switch 24 is a switch for betting maximum credits amount (e.g. equivalent to thirty medals) that can be bet on a single game by one pressing.

A foot display 34 is disposed on the lower front of the main door 13 to display various images relating to games of the slot machine 10. These images are, for example, characters of the slot machine 10 and so on.

Lamps 47 are disposed on both side of the foot display 34 to be illuminated based on preset illuminating patterns for the slot machine 10. The medal cash-out chute 28 is disposed beneath the foot display 34.

An upper display 33 is disposed on the front of the top box 12. The upper display 33 has a display panel to display relationships between points allocated to symbols and awards, etc.

In addition, speakers 29 are provided on the top box 12. A ticket printer 35, a card reader 36, a data display 37 and a keypad 38 are disposed beneath the upper display 33. The ticket printer 35 prints a bar-code, which contains data, such as a credit amount, time and date and an identification number of the slot machine 10, on a ticket and outputs it as a bar-code ticket 39.

A player can play games at another slot machine with the bar-code ticket 39 being read by the other slot machine, and can exchange the bar-code ticket 39 for bills and so on at a predetermined site in an amusement facility (e.g. a cashier in a casino).

A smart card can be inserted into the card reader 36, and the card reader 36 reads data from the inserted smart card and writes data onto the smart card. A smart card is carried by a player and stores the player's identification data, gaming history data of games played by the player and so on.

FIG. 4 is a block diagram showing an electrical configuration of the controller 40 and various components connected to the controller 40, which are provided within the slot machine 10 of the present embodiment. The controller 40 of the slot machine 10 shown in FIG. 4 is a microcomputer and includes interface circuits 102, an input/output (I/O) bus 104, a CPU 106, a ROM 108, a RAM 110, a signal communication interface (I/F) circuit 111, a random number generator (RNG) 112, a speaker drive circuit 122, a hopper drive circuit 124, a display control circuit 128 and a display controller 140.

The interface circuits 102 are connected to the I/O bus 104 and the I/O bus 104 transmits data signals and address signals with the CPU 106.

The start switch 27 is connected to the interface circuits 102. A start command output from the start switch 27 is transmitted to the CPU 106 via the I/O bus 104 after converted into a predetermined signal by the interface circuits 102.

Furthermore, the bet switch 25, the max-bet switch 24, the spin/repeat-bet switch 26 and the cash-out switch 23 are connected to the interface circuits 102. A switching signal output from each of the switches 25, 14, 26 and 23 is transmitted to the CPU 106 via the I/O bus 104 after converted into a predetermined signal by the interface circuits 102.

In addition, a medal sensor 43 is connected to the interface circuits 102. The medal sensor 43 is a sensor for detecting a medal(s) has been inserted into the medal insertion slot 21 and disposed inside the medal insertion slot 21. A detection signal output from the medal sensor 43 is transmitted to the CPU 106 via the I/O bus 104 after converted into a predetermined signal by the interface circuits 102.

In addition, the ROM 108 for storing system programs and the RAM 110 for storing various data are connected to the I/O bus 104. Furthermore, the RNG 112, the signal communication I/F circuit 111, the display controller 140, the hopper drive circuit 124, the speaker drive circuit 122 and the display control circuit 128 are connected to the I/O bus 104.

The CPU 106 is triggered by the start switch 27 receiving a game start operation and then reads out the game execution programs to execute a slot game. The game execution programs are programs for executing a slot game on the display 16 via the display controller 140.

Specifically, the game execution programs are programmed to execute a slot game, in which symbols are scrolled and then stopped in the fifteen display areas q1a to q3e (see FIG. 5) (symbols had been arranged are rearranged) and an award is provided based on displayed symbols and points allocated thereto.

The signal communication I/F circuit 111 is connected to a hall server etc. and transmits gaming history data of the slot machine 10 etc. to the hall server. In addition, the signal communication I/F circuit 111 receives various data transmitted from the hall server.

The RNG 112 generates random numbers for determining whether or not to achieve a winning combination in a slot game executed on the display 16.

The display control circuit 128 controls displaying a payout amount on the payout counter 48 provided at the lower-left area on the display 16.

The speaker drive circuit 122 outputs sound data to the speakers 29. Specifically, the CPU 106 reads the sound data stored in the ROM 108 and transmits the sound data to the speaker drive circuit 122 via the I/O bus 104. As a result, predetermined effect sounds are output from the speakers 29.

The hopper drive circuit 124 outputs a cash-out command to the hopper 44 when providing a cash-out. Specifically, the CPU 106 outputs a drive command to the hopper drive circuit 124 via the I/O bus 104 when receiving the cash-out command from the cash-out switch 23. As a result, the hopper 44 cashes out medals equivalent to current credits stored in a prescribed memory area within the RAM 110.

The display controller 140 controls displaying executions of slot games on the display 16. Specifically, the CPU 106 generates an image display command according to a status and a game result of a slot game and then outputs the image display command to the display controller 140 via the I/O bus 104. On receiving the image display command, the display controller 140 generates a drive command for the display 16 based on the image display command and then outputs the drive command to the display 16. As a result, prescribed images are displayed on the display 16.

Next, relationships between symbols displayed in the display areas q1a to q3e on the display 16 and points displayed together with the symbols and awards to be provided to a player will be explained with reference to FIG. 2.

Any one of seven symbols “LIGHTING”, “$”, “A”, “K”, “Q”, “J” and “UMBRELLA” will be displayed in each of the display areas q1a to q3e on the display 16. In addition, relationships between points displayed together with symbols and awards are defined as shown in FIG. 2.

For example, no award is provided when a total of points (p) allocated to all “LIGHTING” symbols is less than 10p. An award with ten medals is provided when a total points are 10p to 19p. An award with fifty medals is provided when a total points are 20p to 39p. An award with five hundred medals is provided when a total points are 40p to 69p. An award with two thousand medals is provided when a total points are 70p to 99p. An award with two thousand medals is provided when a total points are 70p to 99p. An award with five thousand medals is provided when a total points are equal-to or more-than 100p.

Alternatively, no award is provided when a total of points (p) allocated to all “UMBRELLA” symbols is less than 20p. An award with two medals is provided when a total points are 20p to 39p. An award with twenty medals is provided when a total points are 40p to 69p. An award with one hundred medals is provided when a total points are 70p to 99p. An award with two hundred medals is provided when a total points are equal-to or more-than 100p.

As mentioned above, awards are determined according to not the number of displayed symbols but a total of points allocated to identical symbols.

In addition, in the present embodiment, appearing probabilities in the display areas become higher in the order “LIGHTING”, “$”, “A”, “K”, “Q” “J” and “UMBRELLA”. The appearing probability of “UMBRELLA” symbol is highest and the appearing probability of “LIGHTING” symbol is lowest. Therefore, the controller 40 shown in FIG. 4 controls image effects displayed on the display so that symbols which may bring more higher awards appear in the display areas q1a to q3e at lower probability.

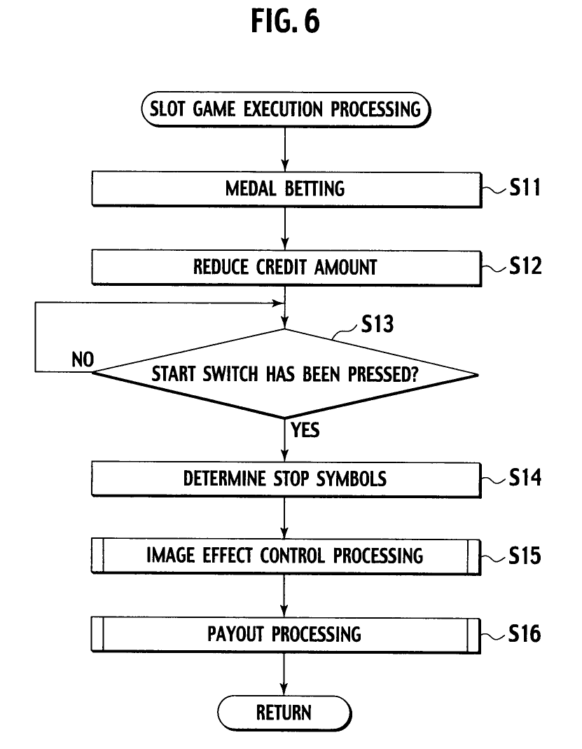

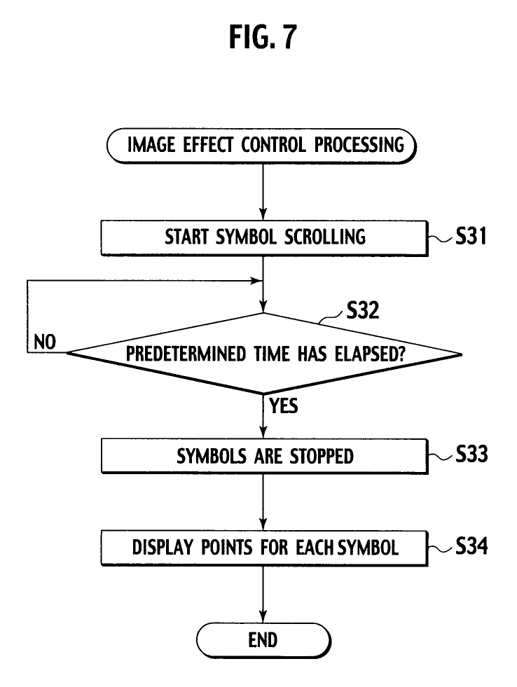

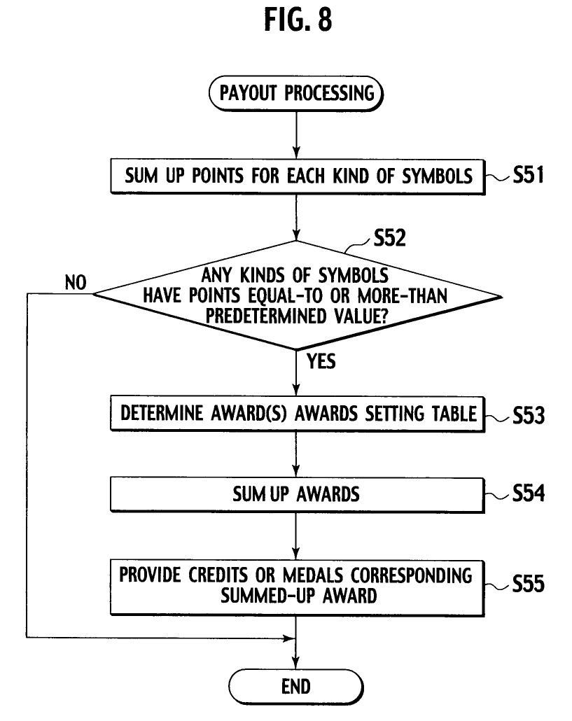

Next, operations of the slot machine 10 in the first embodiment will be explained with reference to flow-charts shown in FIG. 6, FIG. 7 and FIG. 8. FIG. 6 is a flow-chart showing procedures in slot game execution processing executed by the slot machine 10 in the first embodiment.

First, the CPU 106 shown in FIG. 4 accepts a player's bet with medals or credits (step S11). Specifically, when the player placed a bet with a desired credit amount by pressing the bet switch 25 or inserted medals corresponding to a desired medal amount into the medal insertion slot 25, the amount is input as a bet amount.

The CPU 106 reduces current credits by the credits amount when the bet has been placed by pressing the bet switch 25 (step S12). For example, if a ten-credit bet has been placed under thirty credits, the credits become twenty by reducing.

The CPU 106 judges whether or not the start switch 27 has been pressed (step S13). If the start switch 27 has been pressed (YES in step S13), stop symbol determination processing is executed (step S14). In this processing, symbols to be displayed in the display areas q1a to q3e are determined based on random numbers generated by the RNG 112.

The CPU 106 executes image effect control processing (step S15). In this processing, the stop symbols determined in step S14 are displayed in the display areas q1a to q3e. The image effect control processing will be explained later in detail.

Subsequently, the CPU 106 executes payout processing based on the symbols had been displayed in the display areas q1a to q3e and after-mentioned total points (step S16). The payout processing will be explained later in detail.

Next, the image effect control processing of step S15 in FIG. 6 will be explained with reference to FIG. 7.

First, the CPU 106 transmits a command signal to start symbol scrolling to the display controller 140. The display controller 140 starts symbol scrolling in the display areas q1a to q3e on the display 16 on receiving the command signal (step S31).

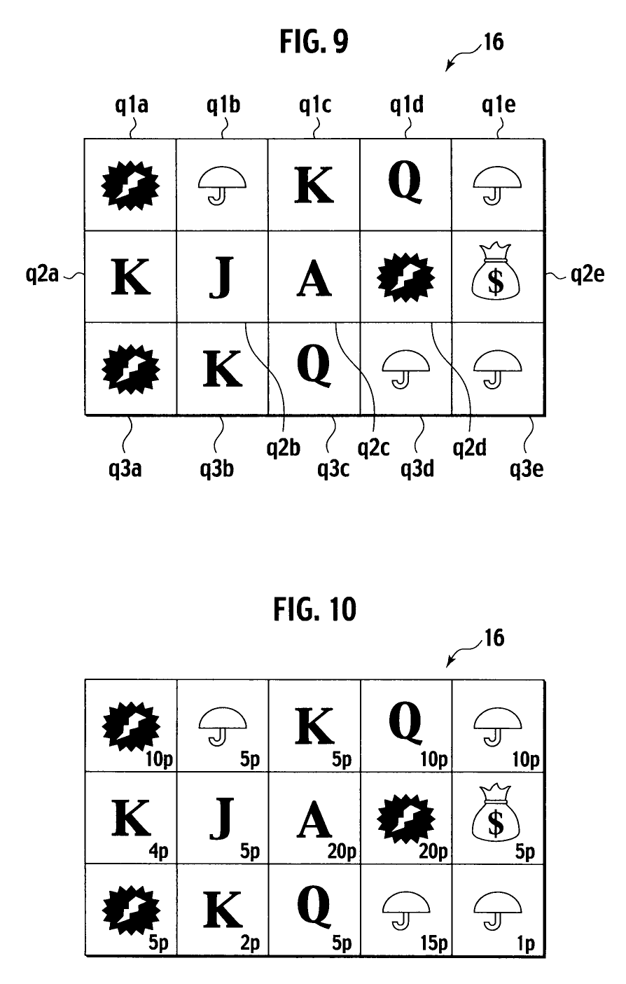

The CPU 106 counts an elapsed time (step S32) and if a predetermined time (e.g. five seconds) has elapsed (YES in step S32) the CPU 106 stops symbols sequentially in the display areas q1a to q3e. As a result, as shown in FIG. 9, symbols are come to stops in the display areas q1a to q3e, respectively.

Subsequently, the CPU 106 displays points (p) for each of the displayed symbols (step S34). As a result, points are allocated at a lower-right position of each of the symbols as shown in FIG. 10. And then, this processing is terminated.

Next, the payout processing of step S16 in FIG. 6 will be explained with reference to FIG. 8.

First, the CPU 106 confirms the points allocated to the symbols in the process of step S34 in FIG. 7 and sums up the points allocated to identical symbols, respectively (step S51). For example, as shown in FIG. 10, three “LIGHTING” symbols have appeared and the points 10p, 5p and 20p have been allocated thereto, thus the total points thereof are 35p. In addition, one “$” symbol has appeared and the points 5p have been allocated thereto, thus the total points thereof are 5p. One “A” symbol has appeared and the points 20p have been allocated thereto, thus the total points thereof are 20p. Furthermore, three “K” symbols have appeared and the points 4p, 2p and 5p have been allocated thereto, thus the total points thereof are 11p. Two “Q” symbols have appeared and the points 5p and 10p are allocated thereto, thus the total points thereof are 15p. In addition, one “J” symbol has appeared and the points 5p have been allocated thereto, thus the total points thereof are 5p. If four “UMBRELLA” symbols have appeared and the points 5p, 15p, 10p and 1p have been allocated thereto, thus the total points thereof are 31p.

And then, the CPU 106 judges whether or not any kinds of symbols have points equal-to or more-than each predetermined value (step S52). Here, since the predetermined value is “10” with respect to each symbol “LIGHTING”, “$”, “A” and “K” as shown in FIG. 2, an award is provided when total points thereof are equal-to or more-than 10p. In addition, since the predetermined value is “20” with respect to each symbol “Q”, “J” and “UMBRELLA”, an award is provided when total points thereof are equal-to or more-than 20p.

The CPU 106 determines an award with respect to each kind of symbols which has total points equal-to or more-than the predetermined value thereof with reference to the awards setting table shown in FIG. 2 (step S53). For example, the total points of “LIGHTING” symbols are 35p which reach the predetermined value “10”, thus a fifty-medal award is provided according to the awards setting table.

In addition, the total points of “$” symbol are 5p which don't reach the predetermined value “10”, thus no award is provided. The total points of “A” symbol are 20p which reach the predetermined value “10”, thus a twenty-medal award is provided. Furthermore, the total points of “K” symbols are 11p which reach the predetermined value “10”, thus a one-medal award is provided. The total points of “Q” symbols are 15p which don't reach the predetermined value “20”, thus no award is provided. In addition, the total points of “J” symbol are 5p which don't reach the predetermined value “20”, thus no award is provided. The total points of “UMBRELLA” symbols are 31p which reach the predetermined value “20”, thus a two-medal award is provided.

Next, the CPU 106 sums up awards (step S54). In the example shown in FIG. 10, a summed-up award with seventy-three medals is provided.

Subsequently, the CPU 106 provides credits or medals corresponding to the summed-up award (step S55). Specifically, seventy-three medals or credits are awarded. In this manner, the payout processing is executed.

As explained above, in the slot machine 10 according to the first embodiment of the present invention, symbols are scrolled and then stopped in the fifteen display areas q1a to q3e and points are allocated at the lower-right position of each of the symbols. And then, if total points allocated to all identical symbols reach a predetermined value, an award is provided according to the total value. Therefore, since an award to be provided to a player is determined according to both displayed symbols and points allocated thereto, various kinds of payout amounts can be prepared.

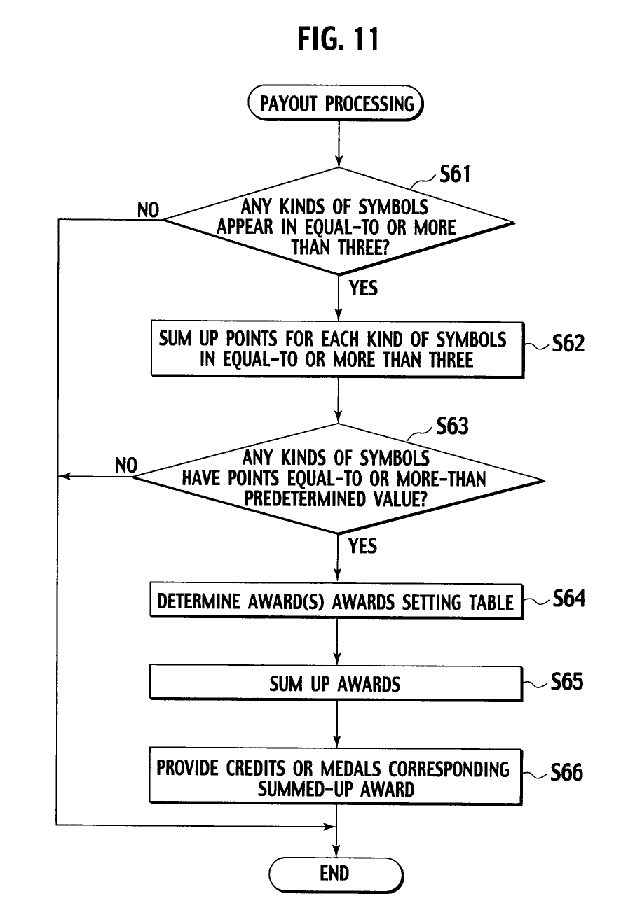

Next, a modified example of the slot machine 10 in the first embodiment will be explained. In the slot machine of the modified example, an award based on a total points allocated to symbols only when equal-to or more-than a predetermined number (e.g. three) of the symbols have appeared. Since payout processing is different from that in the first embodiment shown in FIG. 8, only the payout processing in the modified example will be explained hereinbelow with reference to FIG. 11.

First, the CPU 106 judges whether or not any kinds of symbols have appeared equal-to or more-than three among all kinds of symbols had been displayed in the display areas q1a to q3e (step S61). If no kind of symbols has appeared equal-to or more-than three (NO in step S61), this processing is terminated. In other words, no payout is awarded.

If any kinds of symbols have appeared equal-to or more-than three (YES in step S61), the CPU 106 confirms the points allocated to the symbols in the process of step S34 in FIG. 7 and sums up the points allocated to identical symbols which have appeared equal-to or more-than three, respectively (step S62). For example, as shown in FIG. 10, three “LIGHTING” symbols have appeared and the points 10p, 5p and 20p have been allocated thereto, thus the total points thereof are 35p. In addition, three “K” symbols have appeared and the points 4p, 2p and 5p have been allocated thereto, thus the total points thereof are 11p. Four “UMBRELLA” symbols have appeared and the points 5p, 15p, 10p and 1p have been allocated thereto, thus the total points thereof are 31p.

And then, the CPU 106 judges whether or not any kinds of symbols have points equal-to or more-than each predetermined value (step S63). Here, since the predetermined value is “10” with respect to each symbol “LIGHTING”, “$”, “A” and “K” as shown in FIG. 2, an award is provided when total points thereof are equal-to or more-than 10p. In addition, since the predetermined value is “20” with respect to each symbol “Q”, “J” and “UMBRELLA”, an award is provided when total points thereof are equal-to or more-than 20p.

The CPU 106 determines an award with respect to each kind of symbols which has total points equal-to or more-than the predetermined value thereof with reference to the awards setting table shown in FIG. 2 (step S64). For example, the total points of “LIGHTING” symbols are 35p which reach the predetermined value “10”, thus a fifty-medal award is provided according to the awards setting table.

In addition, the total points of “K” symbols are 11p which reach the predetermined value “10”, thus a one-medal award is provided. The total points of “UMBRELLA” symbols are 31p which reach the predetermined value “20”, thus a two-medal award is provided.

Next, the CPU 106 sums up awards (step S65). In the example shown in FIG. 10, a summed-up award with fifty-three medals is provided.

Subsequently, the CPU 106 provides credits or medals corresponding to the summed-up award (step S66). Specifically, fifty-three medals or credits are awarded. In this manner, the payout processing in the modified example is executed.

As explained above, in the slot machine 10 according to the modified example of the first embodiment, symbols are scrolled and then stopped in the fifteen display areas q1a to q3e and points are allocated at the lower-right position of each of the symbols. And then, if identical symbols are displayed equal-to or more-than three and also total points allocated to all of the identical symbols reach a predetermined value, a award is provided according to the total value. Therefore, since an award to be provided to a player is determined according to both the number of displayed symbols and points allocated thereto, various kinds of payout amounts can be prepared.

Note that, the predetermined number of symbol for providing an award is set to three in the above-explained modified example. However, the predetermined number may be set to a number other than three (such as, two, four or five).

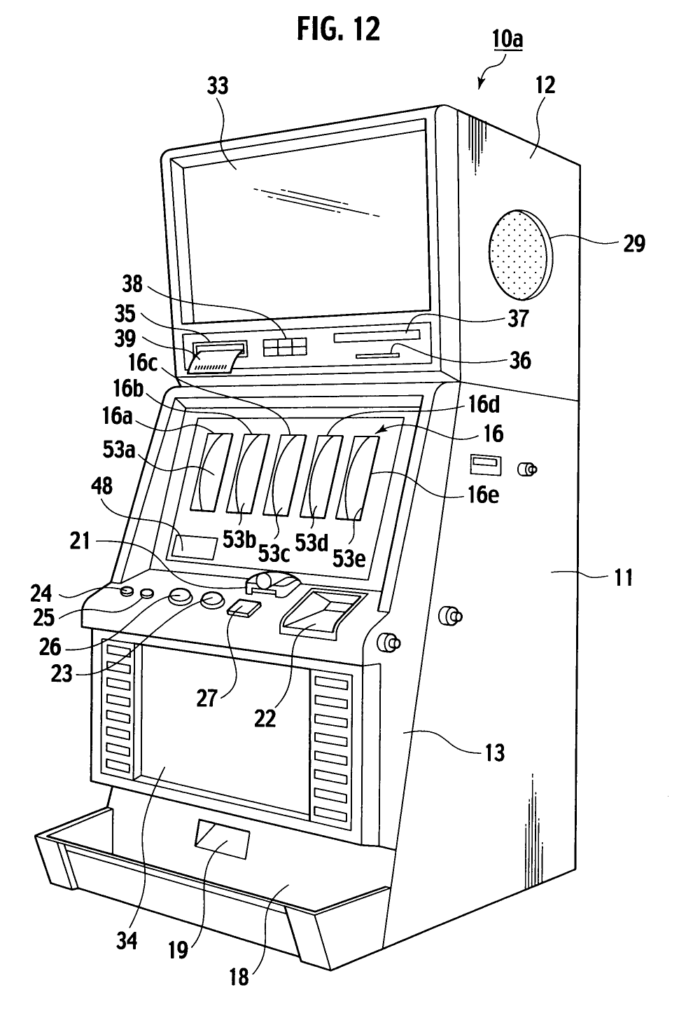

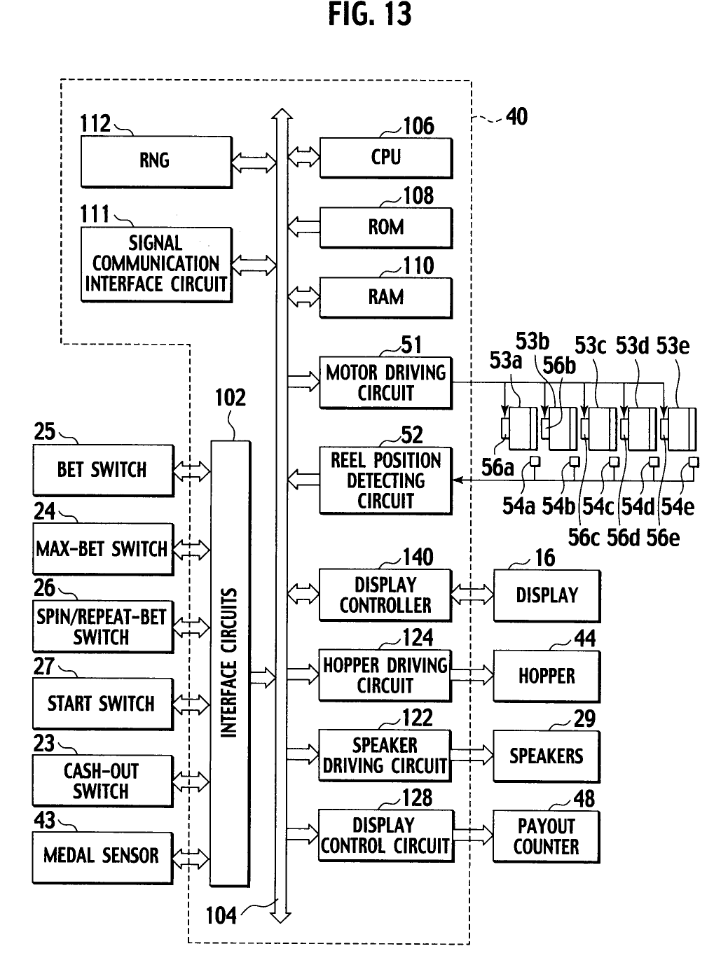

Next, a slot machine in a second embodiment according to the present invention will be explained with reference to FIG. 12. As shown in FIG. 12, the slot machine 10a in the second embodiment includes a cabinet 11, a top box 12 provided on top of the cabinet 11 and a main door 13. The cabinet 11 has a display 16 disposed on its plane facing a player. In addition, various component devices are disposed within the cabinet 11, such as the controller 40 (see FIG. 13) for electrically controlling the slot machine 10a and a hopper 44 (see FIG. 13) for controlling an insertion, pooling, and a cash-out of medals.

Here in the present embodiment, medals are used for gaming media used at game executions. However, gaming media are not limited to medals only. For example, coins, tokens, electronic money or other equivalent electronic value information (credits) may be also used as gaming media.

The main door 13 is attached to the cabinet 11 so that it can be opened and closed. The display 16 is disposed on an upper portion of the main door 13. In addition, five windows 16a to 16e, through which the inside behind the display 16 can be seen, are provided on the display 16. The display 16 is configured by a transmissive liquid crystal panel, with which each of areas within the five windows 16a to 16e is set in a transmissive state and a remaining area is set as an image-displaying area.

In addition, as explained later, a spinning reel device 53 including five reels 53a to 53e is provided within the cabinet 11 behind the display 16. Therefore a player at the slot machine 10a can see the reels 53a to 53e provided behind the windows 16a to 16e. Tree symbols drawn on each of circumferential surfaces of the reels 53a to 53e can be seen when the reels 53a to 53e are being stopped. In other words, the player can see total fifteen symbols in a three-rows by five columns matrix manner through the windows 16a to 16e when the reels 53a to 53e of the spinning reel device 53 are being stopped.

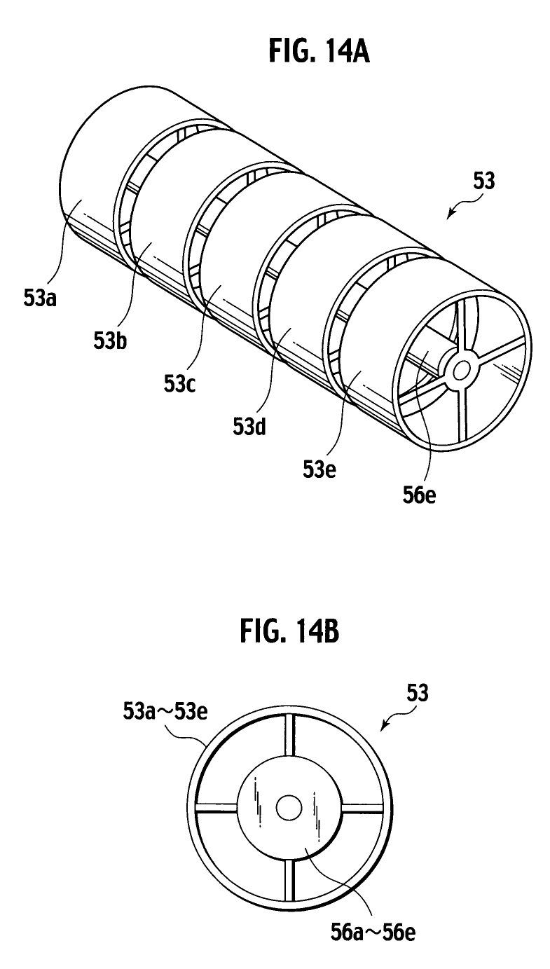

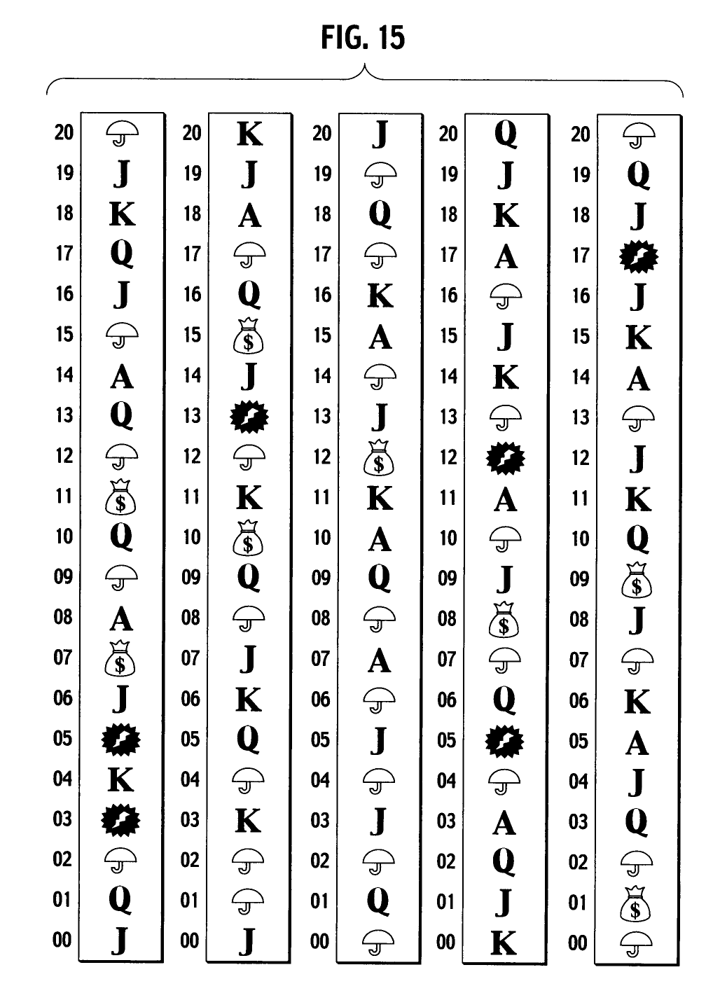

The spinning reel device 53 includes the five reels 53a to 53e each corresponding to the windows 16a to 16e on the window 16 as shown in FIG. 14A and FIG. 14B. Furthermore, as shown in FIG. 15, twenty-one symbols are drawn at even intervals on each circumferential surface of the reels 53a to 53e. These symbols are composed of seven symbols “LIGHTING”, “$”, “A”, “K”, “Q”, “J” and “UMBRELLA”. Here, the numbers of each kind of symbols drawn on each circumferential surface of the reels 53a to 53e become larger in the order “LIGHTING”, “$”, “A”, “K”, “Q”, “J” and “UMBRELLA”. In other words, the appearing probability of “UMBRELLA” symbol is highest and the appearing probability of “LIGHTING” symbols is lowest. Therefore, the larger award may be brought by a kind of symbols, the lower the appearing probability of the kind of symbols becomes.

And then, three symbols on each of the reels 53a to 53e can be seen through the corresponding windows 16a to 16e by the player. Therefore, symbols are arranged and then rearranged by spinning/being-stopped of the reels 53a to 53e.

In addition, a payout counter 48 for displaying a payout amount is disposed at the lower-left area on the display 16 shown in FIG. 12.

A medal insertion slot 21, into which medals are inserted at game plays, and a bill validator 22, which validates bills and accepts valid ones, are disposed beneath the display 16. Various operational switches are disposed nearby the medal insertion slot 21 and the bill validator 22.

A cash-out switch 23, a max-bet switch 24, a bet switch 25, a spin/repeat-bet switch 26 and the start switch 27 are provided as the operational switches.

The bet switch 25 is a switch for determining a bet amount on each slot game executed by on the display 16. Each time the bet switch 25 is pressed, one credit corresponding to one medal is bet.

The spin/repeat-bet switch 26 is a switch for placing a bet again on a current slot game without changing a bet amount had been placed by the bet switch 25 on the last slot game.

The start switch 27 is a switch for starting a slot game after a bet with desired credits has been placed by the bet switch 25. A slot game is started with the spinning reel device 53 after a bet has been placed by a medal(s) insertion into the medal insertion slot 21 or by the bet switch 25 and then the start switch 27 has been pressed.

The cash-out switch 23 is a switch for cashing out medals being inserted. The medals to be cashed out are discharged from a medal cash-out chute 28 opened in the front lower part of the main door 13 and then pooled on a medal tray 18.

The max-bet switch 24 is a switch for betting maximum credits amount (e.g. equivalent to thirty medals) that can be bet on a single game by one pressing.

A foot display 34 is disposed on the lower front of the main door 13 to display various images relating to games of the slot machine 10a. These images are, for example, characters of the slot machine 10a and so on.

Lamps 47 are disposed on both side of the foot display 34 to be illuminated based on preset illuminating patterns for the slot machine 10a. The medal cash-out chute 28 is disposed beneath the foot display 34.

An upper display 33 is disposed on the front of the top box 12. The upper display 33 has a display panel to display relationships between points allocated to symbols and awards, etc.

In addition, speakers 29 are provided on the top box 12. A ticket printer 35, a card reader 36, a data display 37 and a keypad 38 are disposed beneath the upper display 33. The ticket printer 35 prints a bar-code, which contains data, such as a credit amount, time and date and an identification number of the slot machine 10a, on a ticket and outputs it as a bar-code ticket 39.

A player can play games at another slot machine with the bar-code ticket 39 being read by the other slot machine, and can exchange the bar-code ticket 39 for bills and so on at a predetermined site in an amusement facility (e.g. a cashier in a casino).

A smart card can be inserted into the card reader 36, and the card reader 36 reads data from the inserted smart card and writes data onto the smart card. A smart card is carried by a player and stores the player's identification data, gaming history data of games played by the player and so on.

FIG. 27 is a block diagram showing an electrical configuration of the controller 40 and various components connected to the controller 40, which are provided within the slot machine 10a of the present embodiment. The controller 40 of the slot machine 10 shown in FIG. 22 is a microcomputer and includes interface circuits 102, an I/O bus 104, a CPU 106, a ROM 108, a RAM 110, a signal communication I/F circuit 111, an RNG 112, a speaker drive circuit 122, a hopper drive circuit 124, a display control circuit 128, a display controller 140, a motor driving circuit 51 and a reel position detecting circuit 52.

The interface circuits 102 are connected to the I/O bus 104 and the I/O bus 104 transmits data signals and address signals with the CPU 106.

The start switch 27 is connected to the interface circuits 102. A start command output from the start switch 27 is transmitted to the CPU 106 via the I/O bus 104 after converted into a predetermined signal by the interface circuits 102.

Furthermore, the bet switch 25, the max-bet switch 24, the spin/repeat-bet switch 26 and the cash-out switch 23 are connected to the interface circuits 102. A switching signal output from each of the switches 25, 14, 26 and 23 is transmitted to the CPU 106 via the I/O bus 104 after converted into a predetermined signal by the interface circuits 102.

In addition, a medal sensor 43 is connected to the interface circuits 102. The medal sensor 43 is a sensor for detecting a medal(s) has been inserted into the medal insertion slot 21 and disposed inside the medal insertion slot 21. A detection signal output from the medal sensor 43 is transmitted to the CPU 106 via the I/O bus 104 after converted into a predetermined signal by the interface circuits 102.

In addition, the ROM 108 for storing system programs and the RAM 110 for storing various data are connected to the I/O bus 104. Furthermore, the RNG 112, the signal communication I/F circuit 111, the display controller 140, the hopper drive circuit 124, the speaker drive circuit 122, the display control circuit 128 the motor driving circuit 51 and the reel position detecting circuit 52 are connected to the I/O bus 104.

The CPU 106 is triggered by the start switch 27 receiving a game start operation and then reads out the game execution programs from the ROM 108 to execute a slot game. The game execution programs are programs for executing a slot game by driving the driving motors 56a to 56e of the spinning reel device 53 via the motor driving circuit 51.

Specifically, the game execution programs are programmed to execute a slot game, in which the reels 53a to 53e are stopped (symbols had been arranged are rearranged) after scrolling symbols drawn on the circumferential surfaces of the reels 53a to 53e by spinning the reels 53a to 53e of the spinning reel device 53 and an award is provided based on symbols visible trough the windows 16a to 16e (total fifteen three-rows by five-columns symbols) and points allocated to the symbols.

The signal communication I/F circuit 111 is connected to a hall server etc. and transmits gaming history data of the slot machine 10a etc. to the hall server. In addition, the signal communication I/F circuit 111 receives various data transmitted from the hall server.

The RNG 112 generates random numbers for determining whether or not to achieve a winning combination in a slot game executed on the display 16.

The display control circuit 128 controls displaying a payout amount on the payout counter 48 provided at the lower-left area on the display 16.

The speaker drive circuit 122 outputs sound data to the speakers 29. Specifically, the CPU 106 reads the sound data stored in the ROM 108 and transmits the sound data to the speaker drive circuit 122 via the I/O bus 104. As a result, predetermined effect sounds are output from the speakers 29.

The hopper drive circuit 124 outputs a cash-out command to the hopper 44 when providing a cash-out. Specifically, the CPU 106 outputs a drive command to the hopper drive circuit 124 via the I/O bus 104 when receiving the cash-out command from the cash-out switch 23. As a result, the hopper 44 cashes out medals equivalent to current credits stored in a prescribed memory area within the RAM 110.

The display controller 140 controls displaying executions of slot games on the display 16. Specifically, the CPU 106 generates an image display command according to a status and a game result of a slot game and then outputs the image display command to the display controller 140 via the I/O bus 104. On receiving the image display command, the display controller 140 generates a drive command for the display 16 based on the image display command and then outputs the drive command to the display 16. As a result, prescribed images are displayed on the display 16.

The motor driving circuit 51 executes a control to spin the reels 53a to 53e when receiving a drive command signal from the CPU 106 by the start switch 27 being pressed after a slot game has been started and then stop the reels 53a to 53e when a predetermined time (e.g. five seconds) has elapsed.

The reel position detecting circuit 52 receives detecting signals from sensors 54a to 54e provided nearby the reels 53a to 53e to detect stop positions of the reels 53a to 53e. Specifically, identification data is allocated to each symbol on the reels 53a to 53e as magnetic data, a bar-code and so on. The stop positions of the reels 53a to 53e can be detected by reading out the identification data by the sensors 54a to 54e provided correspondingly to the reels 53a to 53e, respectively. As a result, total fifteen three-rows by five-columns symbols displayed in the windows 16a to 16e can be detected.

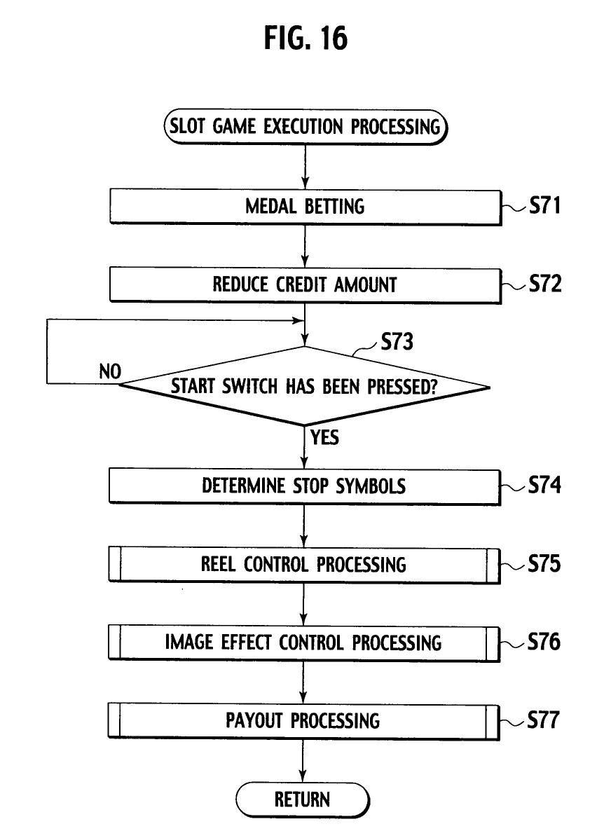

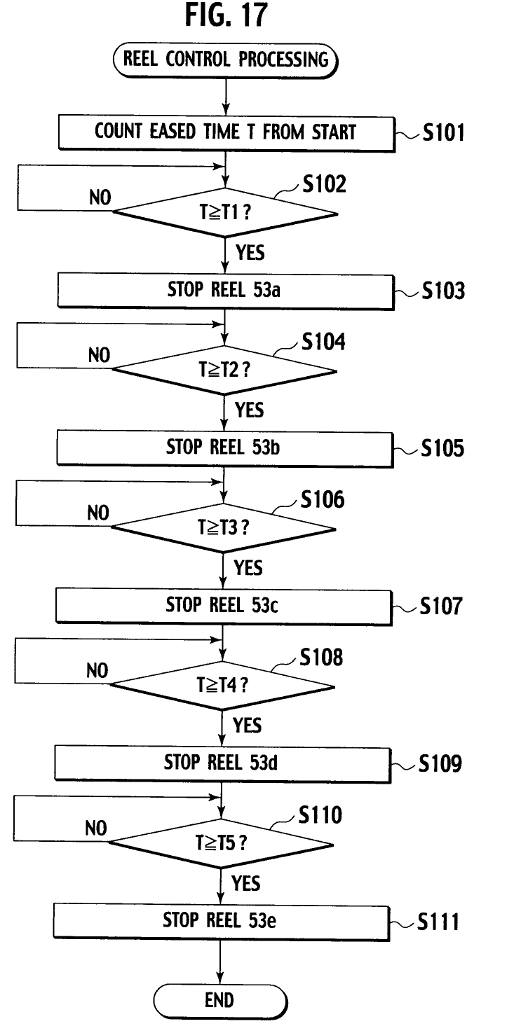

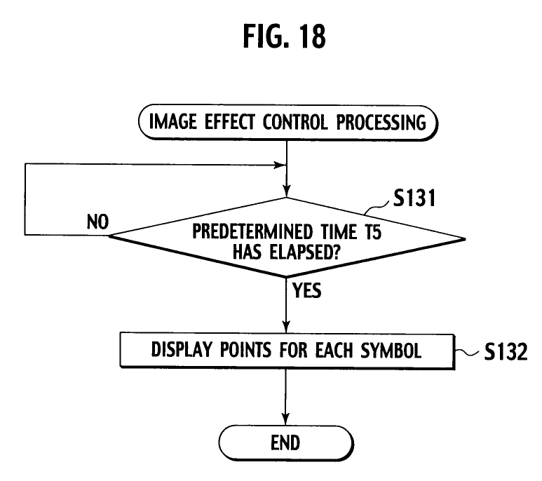

Next, operations of the slot machine 10a in the second embodiment will be explained with reference to flow-charts shown in FIG. 16, FIG. 17 and FIG. 18. FIG. 16 is a flow-chart showing procedures in slot game execution processing executed by the slot machine 10a in the second embodiment.

First, the CPU 106 shown in FIG. 13 accepts a player's bet with medals or credits (step S71). Specifically, when the player placed a bet with a desired credit amount by pressing the bet switch 25 or inserted medals corresponding to a desired medal amount into the medal insertion slot 25, the amount is input as a bet amount.

The CPU 106 reduces current credits by the credits amount when the bet has been placed by pressing the bet switch 25 (step S72). For example, if a ten-credit bet has been placed under thirty credits, the credits become twenty by reducing.

The CPU 106 judges whether or not the start switch 27 has been pressed (step S73). If the start switch 27 has been pressed (YES in step S73), stop symbol determination processing is executed (step S74). In this processing, stop positions of the reels 53a to 53e are determined based on random numbers generated by the RNG 112.

The CPU 106 executes reel control processing to stop the reels 53a to 53e sequentially at the determined symbols (step S75). The reel control processing will be explained later in detail.

The CPU 106 executes image effect control processing (step S76). In this processing, points are displayed at the lower-right position of each of the total fifteen three-rows by five columns symbols after the reels 53a to 53e have stopped. The image effect control processing will be explained later in detail.

Subsequently, the CPU 106 executes payout processing based on the symbols had been displayed in the display areas q1a to q3e and an after-mentioned total points (step S77). The payout processing will be explained later in detail. This payout processing is the same as the processing shown in FIG. 8 or FIG. 11 and explained in the first embodiment.

Next, the reel control processing of step S75 in FIG. 16 will be explained with reference to FIG. 17.

The CPU 106 shown in FIG. 13 transmits a spinning drive command for the reels 53a to 53e to the motor driving circuit 51 when the start switch 27 has been pressed. Furthermore, a timer is set within the RAM 110 to count the elapsed time T from a spinning start of the reels 53a to 53e (step S101).

The CPU 106 judges whether or not the elapsed time T has reached a predetermined time T1 (step S102). If T is equal-to or more-than T1 (YES in step S102), the reel 53a is stopped (step S103).

The CPU 106 judges whether or not the elapsed time T has reached a predetermined time T2 (step S104). If T is equal-to or more-than T2 (YES in step S104), the reel 53b is stopped (step S105).

The CPU 106 judges whether or not the elapsed time T has reached a predetermined time T3 (step S106). If T is equal-to or more-than T3 (YES in step S106), the reel 53c is stopped (step S107).

The CPU 106 judges whether or not the elapsed time T has reached a predetermined time T4 (step S108). If T is equal-to or more than T4 (YES in step S108), the reel 53d is stopped (step S109).

The CPU 106 judges whether or not the elapsed time T has reached a predetermined time T5 (step S110). If T is equal-to or more than T5 (YES in step S110), the reel 53e is stopped (step S111). In this manner, the five reels 53a to 53e are stopped sequentially.

Next, the image effect control processing of step S76 in FIG. 16 will be explained with reference to FIG. 18.

First, the CPU 106 judges whether or not the elapsed time from the spinning start of the reels 53a to 53e has reached the predetermined time T5 (step S131). In other words, it is judged whether or not all of the five reels 53a to 53e have come to stops.

If the predetermined time T5 has elapsed (YES in step S131), points are displayed at lower-right positions of each of the symbols (step S132). As a result, points are displayed on the display 16 at lower-right positions of each of the stopped symbols as shown in above-mentioned FIG. 10. And then, this processing is terminated. In this manner, a slot game is executed.

As explained above, in the slot machine 10a according to the second embodiment of the present invention, total fifteen three-rows by five-columns symbols are displayed in the windows 16a to 16e on the display 16 by spinning and then being-stopped of the reels 53a to 53e. Furthermore, points are displayed at the lower-right position of each displayed symbol.

And then, if total points allocated to all identical symbols reach a predetermined value, an award is provided according to the total value. Therefore, since an award to be provided to a player is determined according to both displayed symbols and points allocated thereto, various kinds of payout amounts can be prepared.

In addition, since the points are allocated after all of the reels 53a to 53e have come to stops, a player can feel a sense of expectant.

Although embodiments of the present invention have been described as above, they are only presented as concrete examples, without particularly limiting the present invention. Concrete arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

In the above detailed description, mainly characteristic portions have been set forth so that the present invention can be understood more easily. The present invention is not limited to the embodiments set forth in the above detailed description and can be applied to other embodiments, with a wide range of applications. In addition, terms and wordings used in the present specification are used to precisely explain the present invention and are not intended to limit the interpretation of the present invention. Also, those skilled in the art will easily conceive, from the concept of the invention set forth in the present specification, other arrangements, systems or methods included in the concept of the present invention. Therefore, it should be appreciated that the scope of the claims includes equivalent arrangements without deviating from the scope of technical ideas of the present invention. In addition, the purpose of the abstract is to facilitate the Patent Office and general public institutions, or engineers in the technological field who are not familiar with patent and legal terms or specific terms to quickly evaluate technical contents and the essence of this application by simple investigation. Therefore, the abstract is not intended to limit the scope of the invention, which should be evaluated by descriptions of the scope of the claims. Furthermore, it is desirable to take into consideration the already disclosed literatures sufficiently in order to completely understand the objects and specific effects of the present invention.

The above detailed description includes processes executed by a computer. The aforementioned descriptions and expressions are described with a purpose that those skilled in the art will understand them most efficiently. In the present specification, each step used for deriving one result should be understood as a self-consistent process. Also, transmission, reception and recording of electric or magnetic signals are executed in each step. In the processes in respective steps, although such signals are expressed as bits, values, symbols, characters, terms or numerals, it should be noted that these are merely used for convenience of explanation. Additionally, although the processes in respective steps may be described using an expression common to human activities, the processes described in the present specification are executed, in principle, by a variety of devices. Furthermore, other arrangements required to execute respective steps are self-evident from the aforementioned description.

What is claimed is:

1. A slot machine comprising:
a display including plural display areas in which symbols are arranged and points are allocated to the symbols; and
a controller operable to:
rearrange symbols in the display areas after receiving an input from an external and also change points of the symbols in the display areas, and
provide, when total points allocated to all identical symbols are equal-to or more-than a predetermined value, an award according to the total points.

2. The slot machine according to claim 1, wherein
the controller is operable to provide the award according to the total points only when equal-to or more-than a predetermined number of the identical symbols have rearranged.

3. The slot machine according to claim 1, wherein
the controller is operable to provide the award becomes higher as an appearing probability of the identical symbols is lower.

4. A slot machine comprising:
a display including plural display areas in which symbols are arranged and points are allocated to the symbols; and
a controller operable to:
(A) rearrange symbols in the display areas after receiving an input from an external,
(B) allocate points to each of the rearranged symbols, and
(C) provide, when total points allocated to all identical symbols are equal-to or more-than a predetermined value, an award according to the total points.

5. The slot machine according to claim 4, wherein
the controller is operable to provide the award according to the total points only when equal-to or more-than a predetermined number of the identical symbols have rearranged.

6. The slot machine according to claim 4, wherein
the controller is operable to provide the award becomes higher as an appearing probability of the identical symbols is lower.

7. A slot machine comprising:
a display including plural display areas in which symbols are arranged and points are allocated to the symbols;
an awards setting table in which relationships between a total of the points and an award are defined and the awards are defined higher as the total of the points becomes larger; and
a controller operable to:
rearrange symbols in the display areas after receiving an input from an external and also change points of the symbols in the display areas, and
provide, when total points allocated to all identical symbols are equal-to or more-than a predetermined value, an award according to the total points with reference to the awards setting table.

8. The slot machine according to claim 7, wherein
the controller is operable to provide the award according to the total points only when equal-to or more-than a predetermined number of the identical symbols have rearranged.

9. The slot machine according to claim 7, wherein
the controller is operable to provide the award higher as an appearing probability of the identical symbols is lower.

10. A control method of a slot machine, comprising:
rearranging symbols had been arranged in plural display areas provided on a display and allocating points to each of the symbols, and
providing, when total points allocated to all identical symbols are equal-to or more-than a predetermined value, an award according to the total points.

11. The control method according to claim 10, wherein
the award according to the total points is provided only when equal-to or more-than a predetermined number of the identical symbols have rearranged.

12. The control method according to claim 10, wherein
the award becomes higher as an appearing probability of the identical symbols is lower.
